(19) United States
(12) Patent Application Publication
(10) Pub. No.: US 2014/0281970 A1
(43) Pub. Date: Sep. 18, 2014

(54) Methods and apparatus for modifying audio information

(71) Applicants: Soenke Schnepel, Luetjensee (DE); Stefan Wiegand, Hamburg (DE); Sven Duwenhorst, Hamburg (DE); Volker W. Duddeck, Hamburg (DE); Holger Classen, Hamburg (DE)

(72) Inventors: Soenke Schnepel, Luetjensee (DE); Stefan Wiegand, Hamburg (DE); Sven Duwenhorst, Hamburg (DE); Volker W. Duddeck, Hamburg (DE); Holger Classen, Hamburg (DE)

(21) Appl. No.: 11/585,352

(22) Filed: Oct. 23, 2006

(51) Int. Cl. G06F 3/16

(52) U.S. Cl. CPC G06F 3/165
USPC 715/716

(57) ABSTRACT

A system receives audio information comprising at least one audio portion associated with an audio type, and provides a capability to modify the audio type. The system renders an amount of modification to the audio type, and renders the audio information resulting from the amount of modification to the audio type. The system provides a graphical user interface with which to render the audio information, and allows a user to modify the audio information, via the graphical user interface, by adjusting the audio type.

### BACKGROUND

Conventional technologies for sound amplification and mixing systems have been employed for processing a musical score from a fixed medium to a rendered audible signal perceptible to a user or audience. The advent of digitally recorded music via CDs coupled with widely available processor systems (i.e., PCs) has made digital processing of music available to even a casual home listener or audiophile. Conventional analog recordings have been replaced by audio information from a magnetic or optical recording device, often in a small personal device such as MP3 and Ipod® devices, for example. In a managed information environment, audio information is stored and rendered as a musical score, or score, to a user via speaker devices operable to produce the corresponding audible sound to a user.

In a similar manner, computer based applications are able to manipulate audio information stored in audio files according to complex, robust mixing and switching techniques formerly available only to professional musicians and recording studios. Novice and recreational users of so-called “multimedia” applications are able to integrate and combine various forms of data such as video, still photographs, music, and text on a conventional PC, and can generate output in the form of audible and visual images that may be played and/or shown to an audience, or transferred to a suitable device for further activity.

### SUMMARY

Digitally recorded audio has greatly enabled the ability of home or novice audiophiles to amplify and mix sound data from a musical source in a manner once only available to professionals. Conventional sound editing applications allow a user to modify perceptible aspects of sound, such as bass and treble, as well as adjust the length by performing stretching or compressing on the information relative to the time over which the conventional information is rendered. Typically, a score is created by combining or layering various musical tracks to create a musical score. A track may contain one particular instrument (such as a flute), a family of instruments (i.e., all the wind instruments), various vocalists (such as the soloist, back up singers, etc.), the melody of the musical score (i.e., the predominant ‘tune’ of the musical score), or a harmony track (i.e., a series of notes that complement the melody).

Conventional technologies for modifying audio information suffer from a variety of deficiencies. In particular, conventional technologies for modifying audio information do not allow for modification of the audio information (i.e., the musical score) based on mapping discrete audio segments arranged by audio type within a control system. Conventional technologies for modifying audio information do not provide a graphical user interface, allowing a user to modify the audio information based on audio type. Further, conventional applications cannot make modifications of the audio information (i.e., the musical score) without perceptible inconsistencies or artifacts (i.e. “crackles” or “pops”) as the audio information is switched, or transitions, from one audio portion to another.

Embodiments disclosed herein significantly overcome such deficiencies and provide a system that includes a computer system executing a audio information modifying process that receives audio information (i.e., a musical score) comprised of audio portions (i.e., ‘tracks’ of the musical score). The audio portions are differentiated by audio type, for example, harmony, melody, intensity, volume, etc. The audio portions are fed to sub mixers based on a value associated with an audio type, for example, a value associated with an intensity of each audio portion. Automation modifiers allow a user to modify audio type (such as melody and harmony, etc) prior to the audio portion being aggregated with other audio portions (associated with similar values of audio type), and fed to a sub mixer. Automation modifiers allow a user to switch from one sub mixer to another (rendering the audio portions that are aggregated at that sub mixer). Automation modifiers allow a user to adjust a value of an audio type (such as volume) and apply that value to all the audio portions that comprise the audio information.

Embodiments disclosed herein provide a graphical user interface that renders the audio information (i.e., visual representation, ‘playing’ the audio information, etc.) and allows a user to modify the audio information. The graphical user interface allows the user to modify the audio information by modifying the audio type. The graphical user interface renders modifications that the user has made to the audio information.

The audio information modifying process receives audio information comprising at least one audio portion associated with an audio type. The audio information modifying process provides a capability to modify the audio type, and renders an amount of modification to the audio type. The audio information modifying process renders the audio information resulting from the amount of modification to the audio type. The audio information modifying process provides a graphical user interface with which to render the audio information, and allows a user to modify the audio information, via the graphical user interface, by adjusting the audio type.

During an example operation of one embodiment, suppose a user desires to modify a musical score. The audio information modifying process renders the musical score on the graphical user interface, displaying the values for intensity, melody, harmony and volume according to a timeline associated with the musical score. The audio information modifying process also identifies various sections of the musical score, such as an intro section, middle section or tail section. In an example embodiment, the audio information modifying process provides a display of video information over a timeline with which the audio information will be associated. The audio information modifying process allows a user to modify the audio information according to the timeline of the video, in essence, synchronizing (and modifying) the audio information with the display of the video information. The graphical user interface provides controls for the audio types. As the user modifies an audio type (for example, intensity, melody, harmony, volume, etc.), the graphical user interface renders the modification the user made to the audio type, and also renders the result of that modification on the audio information. The user can see and hear the result of the modification to the audio types.

Other embodiments disclosed herein include any type of computerized device, workstation, handheld or laptop computer, or the like configured with software and/or circuitry (e.g., a processor) to process any or all of the method operations disclosed herein. In other words, a computerized device such as a computer or a data communications device or any type of processor that is programmed or configured to operate as explained herein is considered an embodiment disclosed herein.

Other embodiments disclosed herein include software programs to perform the steps and operations summarized above and disclosed in detail below. One such embodiment comprises a computer program product that has a computer-readable medium including computer program logic encoded thereon that, when performed in a computerized device having a coupling of a memory and a processor, programs the processor to perform the operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained as embodiments disclosed herein.

It is to be understood that the system disclosed herein may be embodied strictly as a software program, as software and hardware, or as hardware alone. The embodiments disclosed herein, may be employed in data communications devices and other computerized devices and software systems for such devices such as those manufactured by Adobe Systems Incorporated of San Jose, Calif.

### BRIEF DESCRIPTION OF THE DRAWINGS

The foregoing will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 shows a high-level block diagram of a computer system according to one embodiment disclosed herein.

FIG. 2 illustrates a high-level diagram, according to one embodiment disclosed herein.

FIG. 3 illustrates an example screenshot of a graphical user interface, according to one embodiment disclosed herein.

FIG. 4 illustrates a flowchart of a procedure performed by the system of FIG. 1, when the audio information modifying process receives audio information comprising at least one audio portion associated with an audio type, according to one embodiment disclosed herein.

FIG. 5 illustrates a flowchart of a procedure performed by the system of FIG. 1, when the audio information modifying process provides a graphical user interface with which to render the audio information, according to one embodiment disclosed herein.

FIG. 6 illustrates a flowchart of a procedure performed by the system of FIG. 1, when the audio information modifying process allows a user to modify the audio information, via the graphical user interface, by adjusting the audio type, according to one embodiment disclosed herein.

FIG. 7 illustrates a flowchart of a procedure performed by the system of FIG. 1, when the audio information modifying process receives a modification selection from a user to modify the audio information, the modification selection modifying the audio information by modifying the audio type, according to one embodiment disclosed herein.

FIG. 8 illustrates a flowchart of a procedure performed by the system of FIG. 1, when the audio information modifying process receives a modification selection from a user to modify the audio information, and receives the amount of modification of the audio type from a user, according to one embodiment disclosed herein.

FIG. 9 illustrates a flowchart of a procedure performed by the system of FIG. 1, when the audio information modifying process receives audio information comprising at least one audio portion associated with an audio type, and identifies the audio type, according to one embodiment disclosed herein.

### DETAILED DESCRIPTION

Embodiments disclosed herein include an audio information modifying process that receives audio information (i.e., a musical score or musical score) comprised of audio portions (i.e., ‘tracks’ of the musical score). The audio portions are differentiated by audio type, for example, harmony, melody, intensity, volume, etc. The audio portions are fed to sub mixers based on a value associated with an audio type, for example, a value associated with an intensity of each audio portion. Automation modifiers allow a user to modify audio type (such as melody and harmony, etc) prior to the audio portion being aggregated with other audio portions (associated with similar values of audio type), and fed to a sub mixer. Automation modifiers allow a user to switch from one sub mixer to another (rendering the audio portions that are aggregated at that sub mixer). Automation modifiers allow a user to adjust a value of an audio type (such as volume) and apply that value to all the audio portions that comprise the audio information.

Embodiments disclosed herein provide a graphical user interface that renders the audio information (i.e., visual representation, ‘playing’ the audio information, etc.) and allows a user to modify the audio information. The graphical user interface allows the user to modify the audio information by modifying the audio type. The graphical user interface renders modifications that the user has made to the audio information.

The audio information modifying process receives audio information comprising at least one audio portion associated with an audio type. The audio information modifying process provides a capability to modify the audio type, and renders an amount of modification to the audio type. The audio information modifying process renders the audio information resulting from the amount of modification to the audio type. The audio information modifying process provides a graphical user interface with which to render the audio information, and allows a user to modify the audio information, via the graphical user interface, by adjusting the audio type.

FIG. 1 is a block diagram illustrating example architecture of a computer system 110 that executes, runs, interprets, operates or otherwise performs a audio information modifying application 140-1 and process 140-2. The computer system 110 may be any type of computerized device such as a personal computer, workstation, portable computing device, console, laptop, network terminal or the like. As shown in this example, the computer system 110 includes an interconnection mechanism 111 such as a data bus or other circuitry that couples a memory system 112, a processor 113, an input/output interface 114, and a communications interface 115. An input device 116 (e.g., one or more user/developer controlled devices such as a pointing device, keyboard, mouse, etc.) couples to processor 113 through I/O interface 114, and enables a user 108 to provide input commands and generally control the graphical user interface 160 that the audio information modifying application 140-1 and process 140-2 provides on the display 130. The graphical user interface 160 displays visual representation 165 of the audio representation. The communications interface 115 enables the computer system 110 to communicate with other devices (i.e., other computers) on a network (not shown). This can allow access to the audio information modifying application by remote computer systems and in some embodiments, the work area 150 from a remote source via the communications interface 115.

The memory system 112 is any type of computer readable medium and in this example is encoded with a audio information modifying application 140-1. The audio information modifying application 140-1 may be embodied as software code such as data and/or logic instructions (e.g., code stored in the memory or on another computer readable medium such as a removable disk) that supports processing functionality according to different embodiments described herein. During operation of the computer system 110, the processor 113 accesses the memory system 112 via the interconnect 111 in order to launch, run, execute, interpret or otherwise perform the logic instructions of the audio information modifying application 140-1. Execution of audio information modifying application 140-1 in this manner produces processing functionality in a audio information modifying process 140-2. In other words, the audio information modifying process 140-2 represents one or more portions of runtime instances of the audio information modifying application 140-1 (or the entire application 140-1) performing or executing within or upon the processor 113 in the computerized device 110 at runtime.

FIG. 2 illustrates an example diagram of the audio information modifying process 140-2, according to an embodiment disclosed herein. The audio information is comprised of a plurality of audio portions 145-N, each audio portion 145-N associated with an audio type 150-N. The audio portions 145-N are fed to respective sub mixers 155-N. Sections of the audio portions 145-N not fed to the sub mixers 155-N are routed to a muted sub mixer 175. Audio portions 145-6 and 145-7 can be modified by audio type 150-2 prior to being fed to the respective sub mixers 155-N. Audio portion 145-8 can be modified by audio type 150-3 prior to being fed to the respective sub mixers 155-N. Audio type 150-1 provides the capability to switch sub mixers 155-N. Modifying audio type 150-4 applies that modification to all of the sub mixers 155-N.

FIG. 3 illustrates an example screenshot of the graphical user interface 160, according to an embodiment disclosed herein. The graphical user interface 160 renders the audio information as a visual representation 165, according to a timeline 170. The audio information modifying process 140-2 provides the capability to modify the audio types 150-1, 150-2, 150-3, and 150-4. Accordingly, those modifications to the audio types 150-1, 150-2, 150-3, and 150-4 are rendered on the graphical user interface 160.

Further details of configurations explained herein will now be provided with respect to a flow chart of processing steps that show the high level operations disclosed herein to perform the content formatting process.

FIG. 4 is an embodiment of the steps performed by the audio information modifying process 140-2 when it receives audio information comprising at least one audio portion 145-N associated with an audio type 150-N.

In step 200, the audio information modifying process 140-2 receives audio information comprising at least one audio portion 145-N associated with an audio type 150-N. The audio information modifying process 140-2 receives a musical score (i.e., audio information) decomposed into a plurality of tracks (i.e., audio portions 145-N). The musical score (i.e., audio information) is decomposed according to an audio type 150-1, such as intensity. A musical score (i.e., audio information) may have a number of intensities, for example five intensities from one to five. The musical score (i.e., audio information) is decomposed into five tracks (i.e., audio portions 145-N), one for each of the intensities associated with the musical score. In other words, the musical score (i.e., audio information) is decomposed into track one (i.e., audio portion 145-1) that is associated with intensity one, track two (i.e., audio portion 145-2) that is associated with intensity two, track three (i.e., audio portion 145-3) that is associated with intensity three, track four (i.e., audio portion 145-4) that is associated with intensity four, and track five (i.e., audio portion 145-5) that is associated with intensity five. In an example embodiment, these audio portions 145-1, 145-2, 145-3, 145-4, and 145-5 are not modifiable.

Additionally, there may exist audio portions 145-N for audio types 150-N that are capable of modifying the audio portion 145-N. For example, there may exist track 6 (i.e., audio portion 145-6) and track 7 (i.e., audio portion 145-7) that are tracks that are modifiable by an audio type 150-2, such as melody. Track 6 (i.e., audio portion 145-6) may be associated with intensities one, two and there whereas track 7 (i.e., audio portion 145-7) may be associated with intensities four and five.

In an example embodiment, a musical score (i.e., audio information) may have ten tracks (i.e., audio portions 145-N). In this scenario, there may exist ten audio portions 145-N, one for each of the ten intensities, plus ten audio portions 145-N that are modifiable by an audio type 150-2 such as melody, and ten audio portions 145-N that are modifiable by an audio type 150-3 such as harmony. In this example, audio information having ten discrete intensities may have thirty audio portions 145-N. However, more than one modifiable intensity may be associated with an audio portion 145-N

In step 201, the audio information modifying process 140-2 provides a capability to modify the audio type 150-N. The audio information modifying process 140-2 provides the capability to modify the audio type 150-N, for example, by modifying the audio portion 145-N prior to being fed to the sub mixer 155-N. In another example, the audio information modifying process 140-2 provides the ability to modify the audio type 150-N, and in doing so, switching the selection of one audio portion 145-1 to another audio portion 145-N. In yet another example, the audio information modifying process 140-2 provides the ability to modify an audio type 150-N and apply that modification to the entire musical score (i.e., audio information).

In step 202, the audio information modifying process 140-2 renders an amount of modification to the audio type 150-N. The audio information modifying process 140-2 provides the capability to render (i.e., visually or by playing an audio version of the musical score) the amount of modification made to the audio type 150-N.

In step 203, the audio information modifying process 140-2 renders the audio information resulting from the amount of modification to the audio type 150-N. In response to a modification made to an audio type 150-N, the audio information Modifying process 140-2 renders the resulting (i.e., ‘changed’) musical score (i.e., audio information) that results from modifying the audio type 150-N. For example, a user 108 modifies an audio type 150-2 related to melody components of the musical score (i.e., audio information). The audio information modifying process 140-2 renders the version of the musical score (i.e., audio information) that is created as a result of modifying the audio type 150-2.

In step 204, the audio information modifying process 140-2 provides a graphical user interface 160 with which to render the audio information. The audio information modifying process 140-2 provides a graphical user interface 160 to display the audio information, the modifications to the audio information, and the resulting musical score (i.e., modified audio information) that results from the modification to the audio information.

In step 205, the audio information modifying process 140-2 allows a user 108 to modify the audio information, via the graphical user interface 160, by adjusting the audio type 150-N. In an example configuration, the graphical user interface 160 provides a user 108 with controls with which to modify one or more audio types 150-N. The modification of the audio types 150-N is rendered on the graphical user interface 160. The modification of the audio types results in the modification to the musical score (i.e., audio information).

FIG. 5 is an embodiment of the steps performed by the audio information modifying process 140-2 when it provides a graphical user interface 160 with which to render the audio information.

In step 206, the audio information modifying process 140-2 provides a graphical user interface 160 with which to render the audio information. The audio information modifying process 140-2 provides a graphical user interface 160 to display the audio information, the modifications to the audio information, and the resulting musical score (i.e., modified audio information) that results from the modification to the audio information. In an example embodiment, the graphical user interface 160 also displays a video recording such that a user 108 can perform modifications to the musical score (i.e., audio information) to synchronize the musical score with the display of the video recording. For example, a user 108 may increase the intensity of the musical score (i.e., audio information) during a dramatic portion of the video recording, and then decrease the intensity of the musical score (i.e., audio information) during a less dramatic portion of the musical score.

In step 207, the audio information modifying process 140-2 provides a graphical user interface 160 with which to render at least one of:
i) the amount of modification to the audio type, and
ii) the audio information resulting from the amount of modification to the audio type.
   In an example embodiment, the graphical user interface 160 has controls that indicate an amount of modification to the audio type 150-N. As a user 108 modifies the audio type 150-N, that modification is rendered on the graphical user interface 160. Concurrently, the audio information modifying process 140-2 renders the results of the modification to the audio type (i.e., the effect of that modification to the audio information) on the graphical user interface 160. In other words, the graphical user interface 160 has controls (associated with audio types 150-N) that a user 108 can manipulate. As the user 108 manipulates the controls, the user 108 can see the changes to the audio type 150-N. The user 108 can also see the effect those modifications (to the audio type 150-N) have on the musical score (i.e., audio information).

Alternatively, in step 208, the audio information modifying process 140-2 displays a visual representation of the audio information. The audio information modifying process 140-2 renders the audio information by displaying a visual representation 165 of the musical score (i.e., audio information). The visual representation displays, for example, a value associated with the audio type 150-N, such as an integer, or a percentage (i.e., between zero percent and one hundred percent) of the available modification to the audio type 150-N. The visual representation is displayed according to a timeline 170. A user 108 can view the value of an audio type 150-N at any point of the musical score (i.e., audio information) along the timeline 170.

Alternatively, in step 209, the audio information modifying process 140-2 plays an audio representation of the audio information. The audio information modifying process 140-2 renders the audio information by playing an audio representation 165 of the musical score (i.e., audio information). In other words, the user 108 can hear the changes to the musical score (i.e., audio information) via the graphical user interface 160.

FIG. 6 is an embodiment of the steps performed by the audio information modifying process 140-2 when it allows a user 108 to modify the audio information, via the graphical user interface 160, by adjusting the audio type 150-N.

In step 210, the audio information modifying process 140-2 allows a user 108 to modify the audio information, via the graphical user interface 160, by adjusting the audio type 150-N. In an example configuration, the graphical user interface 160 provides a user 108 with controls with which to modify one or more audio types 150-N. As the user 108 makes changes to an audio type 150-N via the graphical user interface 160, the graphical user interface 160 renders that modification. For example, the user 108 changes an audio type 150-1 from a value of one to a value of four. The graphical user interface 160 displays an icon representing the audio type 150-1. The icon (formerly displaying a value of one) now displays a value of four, in response to the user 108 modifying the audio type 150-N. The modification of the audio types results in the modification to the musical score (i.e., audio information).

In step 211, the audio information modifying process 140-2 receives a modification selection from a user 108 to modify the audio information. The modification selection modifies the audio information by modifying the audio type 150-N. In other words, the musical score (i.e., the audio information) is modified by modifying the audio types 150-N.

In step 212, the audio information modifying process 140-2 identifies the audio type 150-N as capable of modifying at least one audio portion 145-1. In an example embodiment, an audio type 150-2 associated with melody, and an audio type 150-2 associated with harmony, are capable of modifying one or more audio portions 145-N prior to the audio portion being fed to the respective sub mixer 155-N.

In step 213, the audio information modifying process 140-2 modifies at least one audio portion 145-N by modifying a value associated with the audio type 150-N. In an example embodiment, a value, such as an integer number, is associated with an audio type 150-2, such as an audio type 150-2 (associated with melody). Modifications to that audio type 150-2 are applied to all modifiable intensities that are associated with a track (i.e., a audio portion 145-6). In other words, a track (i.e., a audio portion 145-6) may contain a plurality of intensities that are modifiable by an audio type 150-2 such as melody or an audio type 150-3, such as harmony. An audio type 150-2 may be capable of modifying more than one audio portion 145-N (containing modifiable intensities).

FIG. 7 is an embodiment of the steps performed by the audio information modifying process 140-2 when it 2 receives a modification selection from a user 108 to modify the audio information.

In step 214, the audio information modifying process 140-2 receives a modification selection from a user 108 to modify the audio information. The modification selection modifies the musical score (i.e., audio information) by modifying the audio type 150-N.

In step 215, the audio information modifying process 140-2 receives a value associated with the modification selection. For example, a user 108, operating the graphical user interface 160, modifies an audio type 150-1, by changing the icon representing that audio type 150-1 from two to four. The audio information modifying process 140-2 receives a value (for example, ‘four’) that is associated with the modification to the audio type 150-1 made by the user 108 on the graphical user interface 160.

In step 216, the audio information modifying process 140-2 identifies the audio type 150-1 as capable of selecting at least one audio portion 145-1 from a plurality of audio portions 145-N. In an example embodiment, an audio type 150-1, such as intensity, changes the musical score (i.e., audio information) by switching from one track (i.e., audio portion 145-2) of one intensity to another track (i.e., audio portion 145-4) of a different intensity, based on the modification to the audio type 150-1.

In step 217, the audio information modifying process 140-2 selects at least one audio portion 145-4 corresponding to modification selection. The audio portion 145-4 is selected from the plurality of audio portions 145-N. In other words, the user 108 changes the audio type 150-1 from a value of ‘two’ to a value of ‘four’, and the audio information modifying process 140-2 switches from rendering one audio portion 145-2 to a different audio portion 145-4, by selecting the audio portion 145-4 that corresponds to the modification made to the audio type 150-1. The audio information modifying process 140-2 makes the switch by selecting the appropriate sub mixer (in this case sub mixer 155-4) that renders the audio portion 145-4.

In step 218, the audio information modifying process 140-2 correlates the value associated with the modification selection to the portion 145-4. In an example embodiment, the user 108 changes the audio type 150-1 related to intensity from ‘two’ to ‘four’. The audio information modifying process 140-2 maps the value of ‘four’ to the audio portion 145-4 that is associated with the audio type 150-1 modification value of ‘four’.

In step 219, the audio information modifying process 140-2 selects the audio portion 145-4. The audio information modifying process 140-2 selects audio portion 145-4 by switching to the appropriate sub mixer (in this case sub mixer 155-4) that renders the audio portion 145-4 on the graphical user interface 160.

In step 220, the audio information modifying process 140-2 renders the audio portion 145-4 on the graphical user interface 160. The audio portion 145-4 may be rendered as a visual representation 165 or an audio representation (i.e., playing the ‘musical score’, or audio information).

In step 221, the audio information modifying process 140-2 mutes those audio portions 145-N within the plurality of audio portions 145-N not rendered on the graphical user interface 160. In an example embodiment, those audio portions 145-N not fed to a sub mixer 155-N and rendered on the graphical user interface 160, are muted.

FIG. 8 is an embodiment of the steps performed by the audio information modifying process 140-2 when it receives a modification selection from a user 108 to modify the audio information.

In step 222, the audio information modifying process 140-2 receives a modification selection from a user 108 to modify the audio information. The modification selection modifies the audio information by modifying the audio type 150-N. The modification selection modifies the musical score (i.e., audio information) through the modification of the audio type 150-N.

In step 223, the audio information modifying process 140-2 receives the amount of modification of the audio type 150-4 from a user 108. In an example embodiment, a user 108 modifies an audio type 150-4, for example, an audio type 150-4 associated with the volume of the musical score (i.e., audio information). In other words, the graphical user interface 160 has a control related to volume, and the user adjusts the volume by manipulating the control on the graphical user interface 160.

In step 224, the audio information modifying process 140-2 applies the amount of modification to the audio information (i.e., the plurality of audio portions 145-N). In an example embodiment, a user 108 modifies the volume by modifying an audio type 150-4 associated with volume, and the volume modification is applied to the plurality of audio portions 145-N that represent the musical score (i.e., audio information). This modification of the musical score (i.e., audio information) is rendered on the graphical user interface 160 both by visual representation 165 and by ‘playing’ an audio representation of the musical score.

FIG. 9 is an embodiment of the steps performed by the audio information modifying process 140-2 when it receives audio information comprising at least one audio portion 145-N associated with an audio type 150-N.

In step 225, the audio information modifying process 140-2 receives audio information comprising at least one audio portion 145-N associated with an audio type 150-N. The audio information modifying process 140-2 receives a musical score (i.e., audio information) decomposed into a plurality of tracks (i.e., audio portions 145-N). The musical score (i.e., audio information) is decomposed according to an audio type 150-1, such as intensity. A musical score (i.e., audio information) may have a number of intensities, for example five intensities from one to five. The musical score (i.e., audio information) is decomposed into five tracks (i.e., audio portions 145-N), one for each of the intensities associated with the musical score.

In step 226, the audio information modifying process 140-2 identifies the audio type as at least one of:
i) intensity,
ii) harmony,
iii) melody, and
iv) volume

While computer systems and methods have been particularly shown and described above with references to configurations thereof, it will be understood by those skilled in the art that various changes in form and details may be made therein without departing from the scope disclosed herein. Accordingly, the information disclosed herein is not intended to be limited by the example configurations provided above.

1. A method comprising:
receiving multiple, simultaneously occurring audio tracks of an audio composition, wherein each audio track is associated with a respective audio type; and
displaying, in a graphical interface, a respective visual representation of each audio track with respect to a timeline, the timeline indicating at least one time interval of a duration of the audio composition;
receiving, via the graphical interface, an incremental modification to a respective audio type of at least one audio track;
responsive to receiving the incremental modification to the respective audio type, modifying respective audio types associated with each of the other audio tracks by the same increment, wherein the respective audio types modified by the same increment are different from one another; and
playing each audio track as modified.

2. (canceled)

3. The method of claim 1, further comprising:
providing the graphical interface with which to render the audio composition, wherein providing a graphical interface with which to render the audio composition comprises:
providing a graphical interface with which to render at least one of:
i) an amount of incremental modification to the respective audio type; and
ii) the audio composition resulting from the amount of incremental modification to the respective audio type.

4. The method of claim 3 wherein providing a graphical interface with which to render the audio composition comprises:
displaying a visual representation of the audio composition.

5. The method of claim 3 wherein providing a graphical interface with which to render the audio composition comprises:
playing an audio representation of the audio composition.

6. (canceled)

7. The method of claim 1, further comprising modifying the audio composition, via the graphical interface, by adjusting the respective audio type, wherein adjusting the respective audio type comprises:
receiving a modification selection to modify the audio composition, the modification selection modifying the audio composition by modifying the respective audio type.

8. (canceled)

9. The method of claim 7 comprising:
identifying the respective audio type as capable of selecting at least one audio track from the audio tracks;
selecting the at least one audio track corresponding to the modification selection, the at least one audio track selected from the plurality of audio tracks; and
rendering the at least one audio track on the graphical interface.

10. (canceled)

11. The method of claim 9 wherein receiving the modification selection to modify the audio composition comprises:
receiving a value associated with the modification selection; and wherein selecting the at least one audio track corresponding to the modification selection comprises:
correlating the value associated with the modification selection to the at least one audio track; and
selecting the at least one audio track.

12-13. (canceled)

14. A computerized device comprising:
a memory;
a processor;
a communications interface;
an interconnection mechanism coupling the memory, the processor and the communications interface;
wherein the memory is encoded with an audio composition managing application that when executed on the processor is configured for managing an audio composition on the computerized device by performing the operations of:
receiving multiple, simultaneously occurring audio tracks of audio information, wherein each audio track is associated with a respective audio type;
displaying, in a graphical interface, a visual representation of each audio track with respect to a timeline, the timeline indicating at least one time interval of a duration of the audio composition;
receiving, via the graphical interface, an incremental modification to a respective audio type of at least one audio track;
responsive to receiving the incremental modification to the respective audio type, modifying respective audio types associated with each of the other audio tracks by the same increment, wherein the respective audio types modified by the same increment are different from one another; and
playing each audio track as modified.

15. (canceled)

16. The computerized device of claim 14 wherein the computerized device is further configured for performing the operations of:
providing the graphical interface with which to render the audio composition;
wherein when the computerized device performs the operation of providing the graphical interface with which to render the audio composition, the computerized device is further configured for performing the operation of:
providing the graphical interface with which to render at least one of:
i) the amount of incremental modification to the respective audio types; and
ii) the audio composition resulting from the amount of incremental modification to the respective audio types.

17-19. (canceled)

20. A non-transitory computer readable medium encoded with computer programming logic that when executed on a process in a computerized device provides audio composition managing, the medium comprising:
instructions for receiving multiple, simultaneously occurring audio tracks of an audio composition, wherein each audio track is associated with a respective audio type;
instructions for concurrently and separately displaying a visual representation of each audio track in a graphical interface, with respect to a timeline, the timeline indicating at least one time interval of a duration of the audio composition;
instructions for receiving, via the graphical interface, an incremental modification to a respective audio type of at least one audio track;
instructions for responsive to receiving the incremental modification to the respective audio type, modifying respective audio types associated with each of the other audio tracks by the same increment, wherein the respective audio types modified by the same increment are different from one another; and
instructions for playing each audio track as modified.

21-29. (canceled)

30. The method of claim 1,
wherein a first audio track corresponds to a first audio type comprising a melody that includes a predominant tune of an audible musical score digitally represented by the audio composition, wherein a second audio track corresponds to a second audio type comprising a harmony that includes a series of notes that complement the melody;
wherein displaying the visual representation of each audio track with respect to the timeline includes:
identifying the harmony and the melody as simultaneously occurring in the audio composition;
extracting the harmony;
extracting the melody;
displaying the visual representation of only the melody in a first isolated view, wherein the first isolated view graphically illustrates at least one audible characteristic of the melody occurring in the audible musical score during the time interval indicated by the timeline;
displaying the visual representation of only the harmony in a second isolated view, wherein the second isolated view graphically illustrates at least one audible characteristic of the harmony occurring in the audible musical score during the time interval indicated by the timeline; and
displaying only at least one sequence of a video within a third isolated view, the at least one sequence synchronized with the time interval indicated by the timeline;
wherein the first isolated view, the second isolated view and the third isolated view are each concurrently displayed within the graphical interface.

31. The method as in claim 30, further comprising:
receiving, via the graphical interface, a modification to an appearance of a visual representation of the melody, wherein the modification translates to an audible adjustment to a portion of the melody occurring during the time interval indicated by the timeline;
rendering a display of a visual representation of a modified melody in place of the visual representation of the melody;
audibly playing the modified melody;
modifying the audible musical score to include the audible adjustment to the modified melody; and
audibly playing the modified musical score in conjunction with playback of the at least one sequence of the video at the time interval indicated by the timeline.

32-37. (canceled)

38. The method as in claim 30,
wherein the visual representation of the harmony illustrates a first available harmony modification amount and a second available harmony modification amount at the time interval indicated by the timeline, the first available harmony modification amount different than the second available harmony modification amount; and
wherein the visual representation of the melody illustrates a first available melody modification amount and a second available melody modification amount at the time interval indicated by the timeline, the first available melody modification amount different than the second available melody modification amount.

39. The method as in claim 30, wherein displaying the visual representation of each audio track with respect to the timeline includes:
receiving a first selection of a first position located on the visual representation of the harmony, the first position synchronized with a first moment of time along the timeline, wherein the visual representation of the harmony is only displayed in the first isolated view and the visual representation of the melody is only displayed in the second isolated view;
in response to the first selection, displaying a first available harmony modification amount that can be applied to at least one audible characteristic of the harmony occurring at the first moment of time;
receiving a second selection of a second position located on the visual representation of the harmony, the second position synchronized with a second moment of time along the timeline, the first moment of time different than the second moment of time; and
in response to the second selection, displaying a second available harmony modification amount that can be applied to at least one audible characteristic of the harmony occurring at the second moment of time, the first available harmony modification amount different than the second available harmony modification amount.

40. The method of claim 1, further comprising modifying the audio composition to audibly represent a modification of at least one of the audio tracks, wherein the modification is received, via the graphical interface, as an adjustment to an appearance of at least a portion of at least one visual representation of a respective audio track displayed on the graphical interface.

41. The method as in claim 40, wherein modifying the audio composition to audibly represent a modification of at least one of the audio tracks includes:
rendering a display of a visual representation of a modified audio track in place of the visual representation of the respective audio track that received the modification;
audibly playing the modified audio track;
modifying the audio composition by rendering the audio composition to include the adjustment, wherein the audio composition comprises a digital representation of an audible musical score; and
audibly playing the modified audio composition.

42. The method as in claim 40, wherein modifying the audio composition to audibly represent a modification of at least one of the audio tracks includes:
receiving a modification to an appearance of the visual representation of a harmony, the modification creating a change in a first available harmony modification amount, the modification further creating an audible adjustment in the harmony based on an extent of the change in the first available harmony modification amount;
in a first isolated view rendering a display of a visual representation of a modified harmony in place of the visual representation of the harmony;
audibly playing the modified harmony without a melody;
modifying the audio composition by rendering the audio composition to include the audible adjustment in the harmony, wherein the audio composition comprises a digital representation of an audible musical score; and
audibly playing the modified musical score.

43. The computer readable medium as in claim 20, wherein a first audio track corresponds to a first audio type comprising a melody that includes a predominant tune of a musical score digitally represented by the audio composition, wherein a second audio track corresponds to a second audio type comprising a harmony that includes a series of notes that complement the melody, and further comprising instructions for extracting respective audio types by:
identifying the harmony and the melody as simultaneously occurring in the audio composition;
extracting the harmony; and
extracting the melody;
wherein displaying the visual representation comprises displaying only the harmony of the audio in a first isolated view, and displaying only the melody of the audio composition in a second isolated view, wherein the first isolated view and the second isolated view are each concurrently displayed within the graphical interface.

44. The computer readable medium as in claim 43, further comprising:
instructions for graphically illustrating at least one audible dynamic of the harmony, in the first isolated view, occurring during the time interval indicated by the timeline; and
instructions for graphically illustrating at least one audible dynamic of the melody, in the second isolated view, occurring during the time interval indicated by the timeline.
